(19) United States
(12) Patent Application Publication
(10) Pub. No.: US 2023/0153892 A1
(43) Pub. Date: May 18, 2023

(54) Electronic Device for Managing Logistics Information and Control Method Thereof

(71) Applicant: Coupang Corp., Seoul (KR)

(72) Inventors: Sang Ho Yim, Seoul (KR); Hyeon Chang Baek, Seoul (KR); Kyung Jae Lee, Seoul (KR); Chang Geun Jin, Seoul (KR); Woong Kim, Seoul (KR); Jae Hyun Kim, Seoul (KR); Lianxi Bai, Seoul (KR)

(21) Appl. No.: 18/156,174

(22) Filed: Jan. 18, 2023

Related U.S. Application Data
(62) Division of application No. 17/010,730, filed on Sep. 2, 2020.

(30) Foreign Application Priority Data
Aug. 6, 2020 (KR) 10-2020-0098805

(51) Int. Cl. G06Q 30/0601; G06Q 10/087

(52) U.S. Cl. CPC G06Q 30/0635; G06Q 10/087

(57) ABSTRACT

According to various embodiments, a logistics information managing method may include identifying at least one of information on a source fulfillment center and information on a target fulfillment center, identifying transfer target candidate order information among order information allocated to the source fulfillment center, and allocating at least a portion of the transfer target candidate order information to the target fulfillment center. Through this, order information previously allocated to a fulfillment center may be reallocated to another fulfillment center, thereby preventing a non-compliance with order processing. Other embodiments are possible as well.

### RELATED APPLICATIONS

This application is a divisional of U.S. application Ser. No. 17/010,730, filed Sep. 2, 2020, which claims priority to the Republic of Korea Patent Application No. 10-2020-0098805, filed Aug. 6, 2020. The contents of these applications are hereby incorporated by reference for their entities.

### BACKGROUND

### Technical Field

The following descriptions relate to a method of managing logistics information and an electronic apparatus for performing the method.

### Description of the Related Art

As the Internet becomes more commonly used, the e-commerce market is expanding. Transactions in the e-commerce market take place online through a network, and products that have been traded in e-commerce may be delivered to a destination set by a customer through a delivery service. As such, as the e-commerce is expanding, a trading brokerage service that mediates a sale between a seller and a buyer and provides the delivery service is also being activated.

A logistics information management system for the trading brokerage service may store products received from a producer in a warehouse of a specific fulfillment center. When a request for delivery of the products is made by a purchaser, the system may pick the corresponding product from the warehouse and send (or deliver) the product to the purchaser through a courier.

Meanwhile, the logistics information management system may operate a plurality of fulfillment centers to provide more effective services. For example, when an order request of a product is made by a purchaser, the logistics information management system may determine a fulfillment center for processing the order in consideration of an attribute (e.g., a destination, stock in the fulfillment center, etc.) of the corresponding order, and assign (or allocate) each order to the determined fulfillment center.

### SUMMARY

### Technical Goals

However, even when orders are assigned to fulfillment centers based on a predetermined condition, it may be difficult to process the assigned order in a specific fulfillment center properly.

For example, for reasons such as a temporary increase in order amount for a specific region or a temporary decrease in an available workforce (e.g., courier) in a specific fulfillment center, there may be a situation in which a number of couriers who can work in a fulfillment center A on a specific date is insufficient compared to an order quantity assigned to the fulfillment center A. In this case, it is difficult to properly complete the task of the assigned order in the fulfillment center A. In order to avoid problems of failure to fulfill the order (e.g., non-compliance with an expected shipping date), some of the orders assigned to the fulfillment center A may be transferred to another fulfillment center (e.g., a fulfillment center B) with a relatively more available workforce. Also, when transferring such order information to another fulfillment center, a lot of data may be quickly transferred, and the order information may be transferred in consideration of a situation of the fulfillment center receiving the order information, so that products can be effectively delivered in accordance with the transfer.

Example embodiments of the present disclosure are to propose a method and apparatus for effectively reassigning (reallocating) some orders assigned to a specific fulfillment center to another fulfillment center as necessary.

### Technical Solutions

According to an aspect, there is provided a logistics information managing method including identifying at least one of information on a source fulfillment center and information on a target fulfillment center, identifying transfer target candidate order information among order information allocated to the source fulfillment center, and allocating at least a portion of the transfer target candidate order information to the target fulfillment center.

According to another aspect, there is also provided an electronic apparatus including a communication module and a processor, wherein the processor is configured to identify at least one of information on a source fulfillment center and information on a target fulfillment center, identify transfer target candidate order information among order information allocated to the source fulfillment center, and allocate at least a portion of the transfer target candidate order information to the target fulfillment center.

### Effects

According to example embodiments of the present disclosure, it is possible to effectively reallocate some orders allocated to a specific fulfillment center to another fulfillment center as necessary. Through this, it is possible to prevent failure to fulfill an ordered task in each fulfillment center and to induce a satisfaction of a purchaser by providing a delivery service according to an expected schedule.

In addition, load balancing between fulfillment centers may be realized by moving a large amount of order data in a short period of time in consideration of a situation of a fulfillment center. Also, by allocating order data based on whether a fulfillment center receiving the order data is available of delivery, the delivery may be effectively performed through the transfer of the order data.

### BRIEF DESCRIPTION OF THE DRAWINGS

FIG. 1 is a diagram illustrating a logistics information management system according to an example embodiment of the present disclosure.

FIG. 2 is a block diagram illustrating an electronic apparatus according to an example embodiment of the present disclosure.

FIG. 3 is a flowchart illustrating a logistics information managing method of an electronic apparatus according to an example embodiment of the present disclosure.

FIG. 4 is a flowchart illustrating an operation of a logistics information management system according to an example embodiment of the present disclosure.

FIG. 5 is a diagram illustrating a user interface for input condition information provided in a logistics information management system according to an example embodiment of the present disclosure.

FIG. 6 is a diagram illustrating a display screen related to progress information provided in a logistics information management system according to an example embodiment of the present disclosure.

### DETAILED DESCRIPTION

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers.

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the

addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

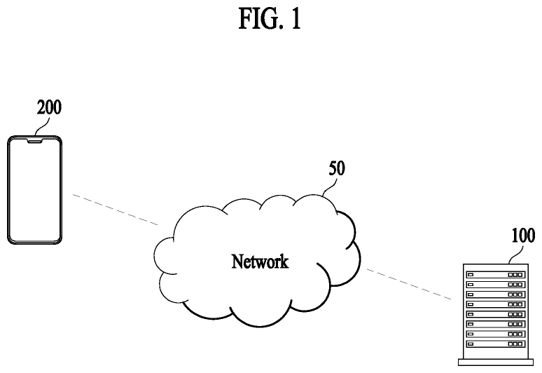

FIG. 1 is a diagram illustrating a logistics information management system according to example embodiments of the present disclosure.

Referring to FIG. 1, a logistics information management system 1 may include an electronic apparatus 100, a network 50, and a user terminal 200.

The electronic apparatus 100 (e.g., server) may be an apparatus for processing various processes for managing logistics information. The electronic apparatus 100 may process stock management of an item received in a fulfillment center, movement management of an item received in the fulfillment center, or management for at least one of picking, rebinning, and packing for delivery. In an example embodiment, the picking may be a process for gathering items stored in the fulfillment center and collecting the items for subsequent processing. The rebinning may be a process of classifying an item corresponding to one delivery information based on the picked items. The packing may correspond to a process of packing the picked or rebinned item to be delivered.

The electronic apparatus 100 may include a plurality of computer systems or computer software implemented as a network server, and may provide various information

by configuring a web page. For example, the electronic apparatus 100 may refer to a computer system and computer software that is connected to a sub-device capable of communicating with another network server through a computer network such as an intranet or the Internet, receives a task performance request, performs a corresponding task, and provides a result of the task. In addition, the electronic apparatus 100 may be understood as a broad concept including a series of application programs that can operate on a network server and various databases built therein. The electronic apparatus 100 may be implemented using a network server program that is provided in various ways based on an operating system such as DOS, Windows, Linux, UNIX, or MacOS, for example.

The network 50 may serve to connect the electronic apparatus 100 and the user terminal 200, or the electronic apparatus 100 and an external device (not shown). For example, the network 50 may provide an access path so that the user terminal 200 is connected to the electronic apparatus 100 to transmit and receive packet data.

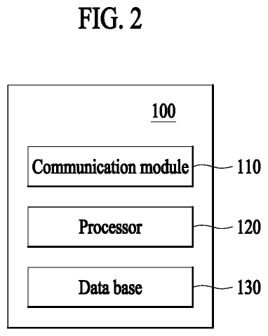

According to an example embodiment of the present disclosure, operations of the logistics information management system 1 may be implemented through the electronic apparatus 100. Also, the user terminal 200 may be connected to the logistics information management system 1 through the network 50. The electronic apparatus 100 may store information received from the user terminal 200 in a database 120 of FIG. 2, or provide information stored in the database 120 of FIG. 2 to the user terminal 200.

According to another example embodiment, the logistics information management system 1 may be implemented in the user terminal 200. For example, a user may install and use the logistics information management system 1 in a form of an application in the user terminal 200 through the network 50.

The logistics information management system 1 according to example embodiments may be implemented by a single physical device, or may be implemented by a plurality of physical devices combined organically. For example, a portion of the components included in the logistics information management system 1 may be implemented by one physical device, and a remaining portion of the components included in the logistics information management system 1 may be implemented by another physical device. For example, one physical device may be implemented as a part of the electronic apparatus 100, and another physical device may be implemented as a part of the user terminal 200 or a part of an external device (not shown). In some cases, components included in the logistics information management system 1 may be distributed and arranged in different physical devices. The distributed components may be organically combined to perform functions and operations of the logistics information management system 1.

FIG. 2 is a block diagram illustrating an electronic apparatus according to an example embodiment of the present disclosure.

Referring to FIG. 2, the electronic apparatus 100 according to example embodiments may include at least one of a communication module 110, a processor 120, and a database 130.

The communication module 110 may function to transmit information stored in the database 130 of the electronic apparatus 100 to another device or receive predetermined information in the electronic apparatus 100 from another device. For example, the communication module 110 may receive predetermined user input information from the user terminal 200 of FIG. 1. In the example embodiment, the communication module 110 may include a transceiver to transmit and receive information.

The processor 120 may control other component other components of the electronic apparatus 100 overall, and process a series of operations for performing a logistics information managing method according to example embodiments of the present disclosure.

The processor 120 may allocate multiple order information to a plurality of fulfillment centers based on a predetermined reference condition. For example, the processor 120 may determine a fulfillment center for processing an order based on an attribute (e.g., an address of a destination, a quantity of stock in the fulfillment center, etc.) of the order and allocate the order such that the order is processed in the determined fulfillment center.

The processor 120 may acquire, from the user terminal 200, information on a source fulfillment center (e.g., a first fulfillment center) from which an order is to be transferred and a target fulfillment center (e.g., a second fulfillment center) in which the transferred order is to be received. For example, the user may specify the source fulfillment center and the target fulfillment center through the user terminal 200 and transmit corresponding information to the electronic apparatus 100.

The processor 120 may identify order information allocated to fulfillment centers. For example, the processor 120 may identify at least one of order information allocated to the source fulfillment center or order information allocated to the target fulfillment center.

As an example, the processor 120 may store order information allocated to each of the fulfillment centers in the database 130 and identify the order information allocated to each of the fulfillment centers from the database 130. As another example, the processor 120 may receive information on the fulfillment centers from another device that individually controls order management processing of the fulfillment centers through the communication module 110, thereby identify the order information allocated to the fulfillment centers.

The processor 120 may identify, from the user terminal 200, information on an attribute of an order to be transferred. For example, information on the attribute of the order to be transferred may include at least one of type information associated with delivery of an order, processing type information associated with packing of an order, or information on a current order processing status in the source fulfillment center. The processor 120 may extract order information matching a corresponding condition based on the information on the attribute of the order to be transferred.

The processor 120 may identify orders corresponding to the conditions among orders previously allocated to the source fulfillment center. The processor 120 may determine that orders corresponding to the conditions are orders expected to be transferred to another fulfillment center. The processor 120 may determine the order corresponding to the condition as transfer target candidate orders. Also, the processor 120 may output information associated with the transfer target candidate orders to outside (e.g., the user terminal 200 or separate output device (not shown).

The processor 120 may allocate at least a portion of the transfer target candidate orders to the target fulfillment center. For example, based on whether the transfer target candidate orders are to be processed in the target fulfillment center, the processor 120 may allocate at least a portion of the transfer target candidate orders to be processed in the target fulfillment center to the target fulfillment center. For example, whether the transfer target candidate orders are to be processed in the target fulfillment center may be determined based on at least one of information on stock received in the target fulfillment center, information on a number of workers in the target fulfillment center, or information on an address of the order.

According to an example embodiment, the processor 120 may transmit and receive predetermined information to and from an external device (not shown) to determine whether a specific order is to be processed in the target fulfillment center. The external device(not shown) may be, for example, a device for managing or processing a new order received from a customer in the logistics information management system 1. For example, the processor 120 may identify information on an order newly received at a specific point in time from an external device (not shown) and determine whether to reallocate the order to the target fulfillment center.

The processor 120 may identify an order expected to be processed in the target fulfillment center (hereinafter, “transfer attempt order”) among the transfer target candidate orders. The processor 120 may identify the transfer attempt orders at a specific point in time and output information (e.g., quantity information) associated with the identified transfer attempt orders.

The processor 120 may attempt allocation to the target fulfillment center for at least a portion of the transfer target candidate orders, for example, the transfer attempt orders. The processor 120 may output (e.g., display) progress information associated with an operation of attempting the allocation to the target fulfillment center for at least a portion of the orders previously allocated to the source fulfillment center. For example, as a result of attempting to the allocation to the target fulfillment center, the processor 120 may identify a quantity of orders succeeded (or failed) to be allocated to the target fulfillment center among at least a portion (e.g., the transfer attempt orders) of the transfer target candidate orders, and output information associated with the quantity.

The database 130 may be a data structure implemented in a predetermined storage space of the electronic apparatus 100, where functions such as storing, searching, deleting, editing, or adding data are freely performed. For example, the database 130 may have fields or components for processing functions such as storing, searching, deleting, editing, or adding data.

The database 130 may store data related to various functions of the electronic apparatus 100. For example, the database 130 may store various information associated with a fulfillment center, and in addition, may store instructions or data for an execution operation of the processor 120. Meanwhile, in the example embodiment, the database 130 may include information corresponding to each fulfillment center. Order information of each fulfillment center may be managed through processing of the database 130.

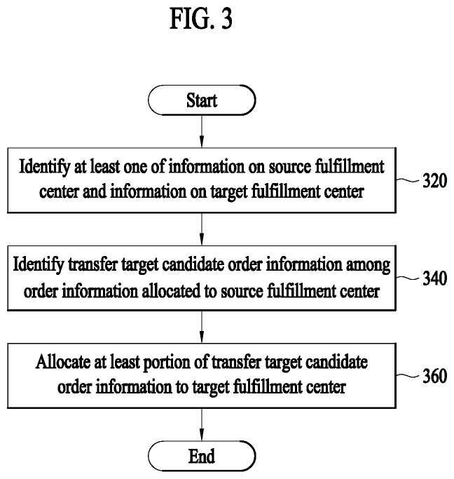

FIG. 3 is a flowchart illustrating a logistics information managing method of an electronic apparatus according to an example embodiment of the present disclosure.

Referring to FIG. 3, in operation 320, the electronic apparatus 100 (e.g., server) according to example embodiments, may identify at least one of information on a source fulfillment center or information on a target fulfillment center.

For example, the electronic apparatus 100 may receive at least one of the information on the source fulfillment center or the information on the target fulfillment center from the user terminal 200.

For example, in operation 320, the electronic apparatus 100 may specify the source fulfillment center and the target fulfillment center among a plurality of fulfillment centers. According to an example embodiment, the source fulfillment center and the target fulfillment center may be identified through a user input. According to another example embodiment, the electronic apparatus 100 may select or suggest the source fulfillment center and the target fulfillment center based on a logistics processing status of each fulfillment center. According to example embodiments of the present disclosure, order information allocated in the source fulfillment center may be allocated to the target fulfillment center.

Subsequently, in operation 340, the electronic apparatus 100 may identify transfer target candidate order information among order information allocated to the source fulfillment center.

For example, the electronic apparatus 100 may determine at least a portion of orders allocated to the source fulfillment center to be a “transfer target candidate order.” In the example embodiment, an order matching a condition input from a user may be determined to be the transfer target candidate order.

For example, the electronic apparatus 100 may determine, to be the transfer target candidate order, order information corresponding to a condition set based on at least one of type information associated with delivery of an order (e.g., an order date, an expected shipping date, delivery company information), processing type information associated with packing of an order, or information on a current order processing status in the source fulfillment center.

For example, the type information associated with delivery of an order may include at least one of service level information associated with a delivery deadline of each order or delivery company type information of an order. The service level information associated with a delivery deadline of each order may include, for example, same-day delivery that is completed within the order date, early morning delivery that is completed by the early morning of the next day of the order, or regular delivery that is completed within a few days after the order date. The delivery company type information of an order may include, for example, information associated with a name of a delivery company or a courier who is to perform delivery of the order.

The processing type information associated with packing of an order may include, for example, information on whether each order is a single order to be packed immediately after an item is picked or a multi-order to be packed with other items after an item is picked.

The information on a current order processing status in the source fulfillment center may include, for example, information related to whether the order is in a state in which the order has not been picked yet in the source fulfillment center.

The electronic apparatus 100 may receive, from the user terminal 200, an input to at least a portion of the type information associated with delivery of an order, the processing type information associated with packing of an order, or the information on a current order processing status in the source fulfillment center, as a transfer condition of an order for which reallocation is to be attempted. The electronic apparatus 100 may identify orders satisfying the set condition based on the received input among the orders previously allocated to the source fulfillment center.

The electronic apparatus 100 may determine order information corresponding to the set condition among the order information allocated to the source fulfillment center to be “transferable order information”, identify information associated with a quantity of transferable orders, and output the information to outside (e.g., the user terminal 200).

For example, the electronic apparatus 100 may receive, from the user terminal 200, information on “transfer target candidate order quantity” corresponding to the transferable order information (e.g., a transferable order quantity). Also, the electronic apparatus 100 may allocate at least a portion of the order information allocated to the source fulfillment center to the target fulfillment center within a range of the transfer target candidate order quantity.

According to an example embodiment, when a quantity of the transfer target candidate order received from the user terminal 200 is less than or equal to a quantity of the transferable order, the electronic apparatus 100 may perform operation 360 as described below. For example, a quantity of orders finally reallocated to the target fulfillment center may be less than or equal to the quantity of the transfer target candidate order. Meanwhile, according to an example embodiment, when a quantity of the transfer target candidate order received from the user terminal 200 is greater than a quantity of the transferable order, the electronic apparatus 100 may output guide information notifying that execution of a command for an order transfer between fulfillment centers has failed (e.g., configuration fail) instead of performing operation 360.

According to another example embodiment, the electronic apparatus 100 may identify the transferable order information based on information on a restricted reallocation quantity set in the target fulfillment center. For example, even when the orders previously allocated to the source fulfillment center satisfy the condition set based on user input information, the electronic apparatus 100 may determine the transferable order quantity only within a range of the restricted reallocation quantity set in the target fulfillment center.

In operation 360, the electronic apparatus 100 according to example embodiments may allocate at least a portion of the transfer target candidate order information to the target fulfillment center. The electronic apparatus 100 may attempt allocation of at least a portion of the transfer target candidate order information to the target fulfillment center in operation 360.

According to an example embodiment, the electronic apparatus 100 may determine whether each order included in the transfer target candidate order information is to be performed in the target fulfillment center, and allocate information on an order determined to be processed in the target fulfillment center to the target fulfillment center.

The electronic apparatus 100 may identify whether each order is to be allocated to the target fulfillment center based on information on stock received in the target fulfillment center, information on a number of workers (e.g., couriers) in the target fulfillment center, or information on an address corresponding to each order information.

At least a portion of order information attempted to be allocated to the target fulfillment center by the electronic apparatus 100 may be successfully allocated to the target fulfillment center, while another portion of the order information may fail to be allocated to the target fulfillment center. For example, order information allocated to the target fulfillment center in operation 360 may be processed in the target fulfillment center. Also, order information that fails to be allocated to the target fulfillment center in operation 360 may be processed in the source fulfillment center. According to another example embodiment, the electronic apparatus 100 may allocate order information failed to be allocated to the target fulfillment center, to another target fulfillment center (e.g., a third fulfillment center) matching a reallocation condition. For example, the electronic apparatus 100 may determine the third fulfillment center to which an order is to be reallocated, based on information on the plurality of fulfillment centers.

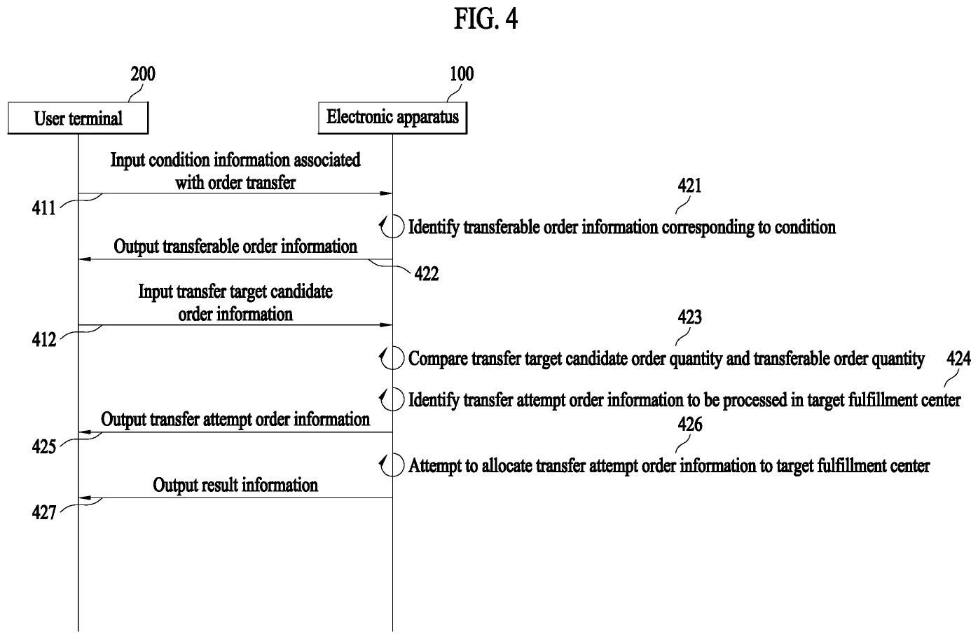

FIG. 4 is a flowchart illustrating an operation of a logistics information management system according to an example embodiment of the present disclosure.

Since the description of FIG. 3 is also applicable here, repeated description of FIG. 4 will be omitted.

Referring to FIG. 4, in operation 411, the logistics information management system 1 according to example embodiments may transmit condition information associated with an order transfer from the user terminal 200 to the electronic apparatus 100. Here, the order transfer may refer to reallocating a portion of order information previously allocated to a source fulfillment center, to a target fulfillment center such that the reallocated portion is processed in the target fulfillment center. Also, the condition information may include at least one of source fulfillment center information, target fulfillment center information, or information for selecting an order to be transferred in the source fulfillment center.

Although FIG. 4 illustrates that the electronic apparatus 100 performs a series of procedures related to condition information as an example, embodiments are not limited thereto. According to another example embodiment, in the logistics information management system 1, the electronic apparatus 100 may perform the procedures of FIG. 4 through communication with a separate server corresponding to each fulfillment center. As an example, the logistics information management system 1 may include a server corresponding to each fulfillment center. The electronic apparatus 100 may perform order transfer processing through communication with the server corresponding to each fulfillment center as described with reference to FIG. 4.

For example, the user may specify a source fulfillment center and a target fulfillment center to which order information is to be reallocated, through the user terminal 200.

Also, the user may input information associated with a condition (hereinafter, also referred to as “condition information”) of an order to be transferred from the source fulfillment center to the target fulfillment center, through the user terminal 200. For example, the “condition information” of the order to be transferred may include at least one of type information associated with delivery of an order, processing type information associated with packing of an order, or information on a current order processing status in the source fulfillment center.

Meanwhile, according to another example embodiment, the electronic apparatus 100 may receive information on the source fulfillment center and condition information associated with a transfer target candidate order from the user through the user terminal 200 and determine candidate target fulfillment centers to which at least a portion of orders allocated to the source fulfillment center are to be reallocated, based on the received information. The electronic apparatus 100 may provide the candidate target fulfillment centers through the user terminal 200 and receive information on a final target fulfillment center from the user, thereby performing the following operations.

In operation 421, based on the condition information associated with the order transfer received from the user terminal 200, the electronic apparatus 100 may identify “transferable order” information corresponding to the condition information.

As an example, the electronic apparatus 100 may determine orders matching the condition information among the orders allocated to the source fulfillment center to be a “transferable order.” As another example, despite the orders matching the condition information among the orders allocated to the source fulfillment center, the electronic apparatus 100 may determine only a portion of the orders matching the condition information to be the “transferable order” based on a condition (e.g., an acceptable reallocation quantity) set in the target fulfillment center.

In operation 422, the electronic apparatus 100 may transmit the “transferable order” information to the user terminal 200. For example, the user terminal 200

may output (e.g., display) the received “transferable order” information through an output device (e.g., a display) included in the user terminal 200.

For example, the information “transferable order” may include quantity information of the “transferable order” expected to be transferred and allocated from the source fulfillment center to the target fulfillment center.

In operation 412, the user may input “transfer target candidate order” information corresponding to the “transferable order” information through the user terminal 200, so that the input “transfer target candidate order” information is transmitted from the user terminal 200 to the electronic apparatus 100.

For example, the “transfer target candidate order” information may include quantity information of “transfer target candidate order” corresponding to a target transfer order quantity input by the user.

Meanwhile, in the example embodiment, with respect to the order information identified in operation 421, the electronic apparatus 100 may allocate the corresponding order information to the target fulfillment center until the quantity information input in operation 412 is satisfied. Also, in the example embodiment, the electronic apparatus 100 may control to prevent picking, rebinning, and packing from being performed while the order transfer is performed for the order information included in the transferable order information.

In operation 423, the electronic apparatus 100 may compare a quantity of the “transfer target candidate order” and a quantity of the “transferable order”, and perform operation 424 only when the quantity of the “transfer target candidate order” is less than or equal to the quantity of the “transferable order.” As described with reference to FIG. 3, when it is determined in operation 423 that the quantity of the “transfer target candidate order” is greater than the “transferable order”, the electronic apparatus 100 may not perform operation 424. For example, when the quantity of the “transfer target candidate order” is greater than the quantity of the “transferable order”, the electronic apparatus 100 may output guide information indicating a failure of a reallocation command through the user terminal 200 or replace the quantity of the “transferable order” with “the transfer target candidate order” to perform operation 424 as follows.

In operation 424, the electronic apparatus 100 may previously determine order information to be processed in the target fulfillment center. For example, the electronic apparatus 100 may determine order information determined to be available of transfer to the target fulfillment center, to be “transfer attempt order” information. The electronic apparatus 100 may attempt allocation to the target fulfillment center within a range of the “transfer attempt order” information in operation 426 as described below.

In operation 425, the electronic apparatus 100 may transmit the “transfer attempt order” information to the user terminal 200 to output information on the “transfer attempt order” to outside (e.g., the display of the user terminal 200). For example, the “transfer attempt order” information may include information on a quantity of orders expected to be successfully allocated in a case of attempting allocation to the target fulfillment center at the time of determining the “transfer attempt order” information.

Subsequently, in operation 426, the electronic apparatus 100 may attempt allocation to the target fulfillment center for at least a portion of the transfer target candidate order information, for example, the transfer attempt order information.

According to an example embodiment, when performing operations 424 and 426, the electronic apparatus 100 may transmit and receive predetermined information to and from an external device (not shown), thereby identifying the “transfer attempt order” information or verifying whether the “transfer attempt order” information is to be allocated to the target fulfillment center. As an example, the external device (not shown) may be a device for managing or processing a new order received from a customer. The electronic apparatus 100 may determine whether a specific order allocated to the source fulfillment center is to be transferred and allocated to the target fulfillment center based on information on the new order received from the external device (not shown). As another example, the aforementioned external device (not shown) may correspond to a component included in the electronic apparatus 100 as part.

In operation 426, at least a portion of the “transfer attempt order” information attempted to be allocated to the target fulfillment center may be successfully allocated to the target fulfillment center, while another portion may fail to be allocated. The electronic apparatus 100 may allow an order allocated to the target fulfillment center to be processed in the target fulfillment center. The electronic apparatus 100 may allow an order that fails to be allocated to the target fulfillment center to be processed in the source fulfillment center or may attempt to allocate the order to another fulfillment center. Also, in the example embodiment, if at least one of the picking, rebinning, and the packing is performed for the corresponding order information in the source fulfillment center while attempting to allocate the transfer attempt order to the target fulfillment center, the corresponding information may be excluded from the transfer.

In operation 427, the electronic apparatus 100 may transmit result information of the attempt of the order allocation to the target fulfillment center performed in operation 426 to the user terminal 200 so as to provide the result information to the user. In operation 427, through the user terminal 200, the user may identify information on at least one of a quantity of orders finally allocated to the target fulfillment center, a quantity of orders attempted to be allocated to the target fulfillment center, and a quantity of orders requested by the user to be allocated to the target fulfillment center.

Meanwhile, although not shown, in the logistics information management system 1 according to various example embodiments, when a quantity of orders allocated to the target fulfillment center is less than a quantity of orders requested to be allocated by the user, the electronic apparatus 100 may continually perform order allocation to the target fulfillment center. When the quantity of orders allocated to the target fulfillment center is equal to the quantity of orders requested to be allocated by the user, the electronic apparatus 100 may suspend an operation of allocating an order to the target fulfillment center.

According to an example embodiment, even if the quantity of orders allocated to the target fulfillment center is less than the quantity of orders requested to be allocated by the user, when a quantity of orders attempted to be allocated to the target fulfillment center reaches the quantity of the “transfer attempt order” determined in operation 424, the electronic apparatus 100 may suspend the operation of allocating an order to the target fulfillment center. According to another example embodiment, even if the quantity of orders allocated to the target fulfillment center is less than the quantity of orders requested to be allocated by the user, when the quantity of orders attempted to be allocated to the target fulfillment center reaches the quantity of the “transferable order” determined in operation 421, the electronic apparatus 100 may be set to suspend the operation of allocating an order to the target fulfillment center. According to another example embodiment, when the quantity of orders allocated to the target fulfillment center is less than the quantity of orders requested to be allocated by the user as described above, and when the quantity of orders attempted to be allocated reaches the quantity of “the transfer attempt order” or the quantity of the “transferable order”, the electronic apparatus 100 may attempt to allocate a remaining order quantity portion to another fulfillment center (e.g., a third fulfillment center).

According to another example embodiment, in accordance with receiving a user input for suspending an operation of allocating an order to the target fulfillment center on progress, the electronic apparatus 100 may suspend the operation of allocating the order to the target fulfillment center. For example, the electronic apparatus 100 may receive, from the user terminal 200, the user input corresponding to the operation of allocating the order.

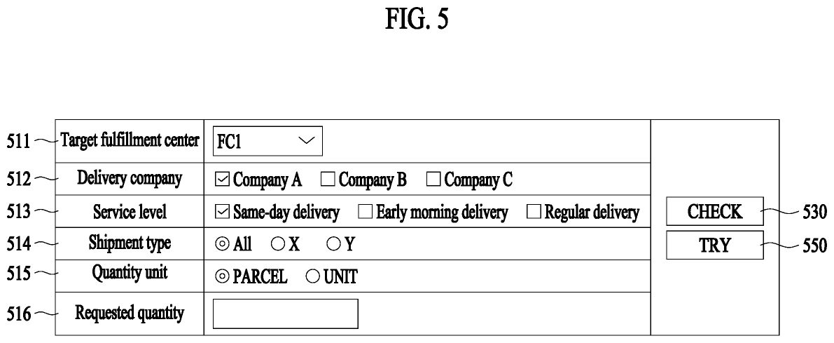

FIG. 5 is a diagram illustrating a user interface for input condition information provided in a logistics information management system according to an example embodiment of the present disclosure.

Referring to FIG. 5, the logistics information management system 1 according to an example embodiment may display a condition information input screen related to an order transfer between fulfillment centers through a display included in the user terminal 200 (or the electronic apparatus 100). For example, a user may input each condition information related to order information reallocation by referencing the condition information input screen illustrated in FIG. 5. In an example embodiment, a source fulfillment center maybe selected in advance. In another example embodiment, a source fulfillment center and a target fulfillment center may be selected on a same screen to perform an order transfer.

For example, a user interface for inputting condition information may include at least a portion of a field 511 in which information on the target fulfillment center (e.g., a name of position in the target fulfillment center, FC1, FC2, FC3) is to be input, a field 512 in which a delivery company type (e.g., company A, company B, and company C) of an order to be allocated to the target fulfillment center is to be input, a field 513 in which a type related to a delivery service level (e.g., same-day delivery, early morning delivery, regular delivery, etc.) of an order to be allocated to the target fulfillment center is to be input, a field 514 in which a processing type, for example, a shipment type (e.g., all, X, Y) related to packing of an order to be allocated to the target fulfillment center is to be input, a field 516 in which a requested quantity of an order to be allocated to the target fulfillment center is to be input, and a field 515 in which a unit (e.g., PARCEL, UNIT) of the requested quantity of the order is to be input.

For example, the user may input the fields of the reference numerals 511 through 515, and then touch a CHECK button 530. When a user input to the CHECK button is received, the user terminal 200 may transmit corresponding user input information to the electronic apparatus 100. The electronic apparatus 100 may determine “transferable order” information corresponding to the user input information and transmit the information to the user terminal 200, so that the “transferable order” information, for example, quantity information of the “transferable order” (not shown) is displayed to the user.

For example, the user may confirm the quantity information of the “transferable order” (not shown) displayed on the display of the user terminal 200 and input the requested quantity of the reference numeral 516 within a range less than or equal to a quantity of the “transferable order.” Also, in accordance with a user input to a TRY button 550 being received, the user terminal 200 may provide the input requested quantity 516 to the electronic apparatus 100 as the quantity information of the “transfer target candidate order.”

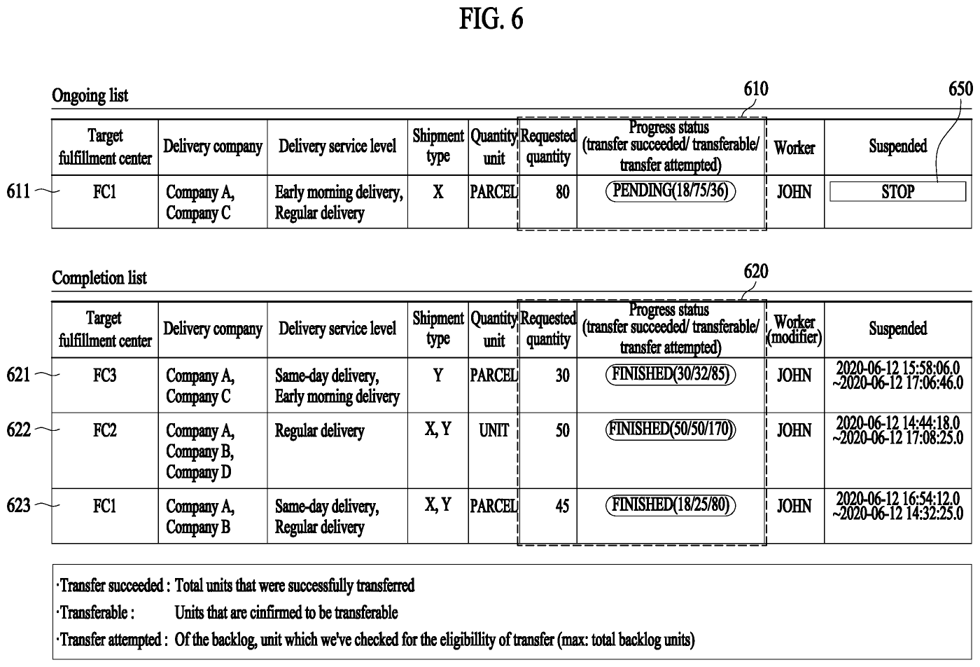

FIG. 6 is a diagram illustrating a display screen related to progress information provided in a logistics information management system according to an example embodiment of the present disclosure.

Referring to FIG. 6, the logistics information management system 1 according to an example embodiment may output a display screen including progress

information associated with an execution of an order transfer between fulfillment centers on a display of the user terminal 200 (or the electronic apparatus 100).

For example, the display screen illustrated in FIG. 6 may include an“ongoing list” indicating information 611 on an ongoing order transfer between fulfillment centers and a “completion list” indicating information 621 through 623 on completed order transfers between fulfillment centers.

For example, as indicated by reference numeral 611 of the “ongoing list”, execution information associated with a case in which order allocation is requested in accordance with “FC1” being determined as the target fulfillment center among a plurality of fulfillment centers may be displayed. For example, regarding a field “progress status” of reference numeral 610, the “ongoing list” may show information on at least one of a quantity of orders for which order allocation to the target fulfillment center has been attempted so far (e.g., transfer attempted), a quantity of orders for which order allocation to the target fulfillment center has been completed so far (e.g., transfer succeeded), or a quantity of “the transfer target candidate order” determined to be available of order allocation at a specific point in time (e.g., transferable).

For example, through the reference numeral 611, among orders allocated to the source fulfillment center, a user may confirm that delivery company information is one of “company A” or “company C”, a delivery service level type corresponds to one of “early morning delivery” or “regular delivery”, and a part of an order corresponding to a shipment type X related to packing of the order is being attempted to be allocated to the target fulfillment center of “FC1.” It can also be confirmed that the user has requested order allocation corresponding to a quantity of 80 [PARCEL] under the condition, order allocation corresponding to 36 [PARCEL] has been attempted so far, and among them, orders of 18 [PARCEL] have been successfully allocated to the target fulfillment center of “FC1.”

According to an example embodiment, the user terminal 200 may receive a user input to a STOP button 650 for suspending an order transfer allocation function currently in progress, so that the logistics information management system 1 suspends the order transfer allocation in progress.

Meanwhile, regarding a field “progress status” of reference numeral 620, the “completion list” may show information on at least one of a quantity of orders for which order allocation to the target fulfillment center is attempted finally (e.g., transfer attempted), a quantity of orders for which order allocation to the target fulfillment center is completed finally (e.g., transfer succeeded), or a quantity of “the transfer target candidate order” determined to be available of order allocation at a specific point in time (e.g., transferable).

For example, as indicated by the reference numerals 621 through 623, the “completion list” may show at least one of information on each target fulfillment center (e.g., “FC3” of the reference numeral 621, “FC2” of the reference numeral 622, and “FC1” of the reference numeral 623), delivery company type information (e.g., company A, company B, company C, and company D), delivery service level type information (e.g., same-day delivery, early morning delivery, regular delivery, etc.), order packing-related shipment type information (e.g., X, Y), information on allocation-requested order quantity and unit (e.g., PARCEL, UNIT), worker information (e.g., JOHN), or information associated with a time used for allocation (e.g., a starting time and a termination time).

Meanwhile, the present disclosure and drawings have been described with respect to preferred embodiments of the present disclosure, although specific terms have been used, they are merely used in a general sense to easily explain the technical contents of the present disclosure and to help understand the present disclosure. It is not intended to limit the scope of the present disclosure. It is apparent to those skilled in the art to which the present disclosure pertains that other modified examples based on the technical idea of the present disclosure can be implemented in addition to the embodiments disclosed herein.

What is claimed is:

1. A method of managing logistics information by an electronic apparatus, the method comprising:
receiving, from a user terminal in data communication with the electronic apparatus over a network, data indicative of one or more attributes of a plurality of orders to re-allocate from a source fulfillment center to a target fulfillment center, the data based on one or more inputs received by the user terminal and including at least a requested number of orders for the re-allocation;
based on the received one or more attributes, identifying at least one of the source fulfillment center or the target fulfillment center for the re-allocation;
based on the received one or more attributes, identifying data relating to one or more candidate orders among a plurality of orders allocated to the source fulfillment center;
determining a number of the one or more candidate orders and a range of numbers of re-allocated orders which can be handled at the target fulfillment center;
based on the number of orders for the re-allocation being (i) less than or equal to the number of the one or more candidate orders and (ii) within the range of numbers of re-allocated orders, re-allocating at least a portion of the one or more candidate orders to the target fulfillment center, wherein the re-allocating of the at least portion of the candidate orders comprises:
causing one or more products associated with the at least portion of the candidate orders to be transferred from the source fulfillment center to the target fulfillment center using one or more programmable devices;
determining, by the electronic apparatus, that at least one of picking, rebinning, or packing has been performed for at least one of the candidate orders at the source fulfillment center;
identifying one or more products associated with the at least one candidate order for which the at least one of the picking, the rebinning, or the packing has been performed; and
preventing the identified one or more products from being transferred from the source fulfillment center to the target fulfillment center by the one or more programmable devices; and
transmitting data relating to the re-allocated portion of the one or more candidate orders to the user terminal via the network, so as to enable the user terminal to display the data relating to the re-allocated portion of the one or more candidate orders.

2. The method of claim 1,
wherein the received one or more attributes are based on data relating to at least one of delivery of an order, packing of an order, or a current order processing status in the source fulfillment center.

3. The method of claim 1, wherein the re-allocating the at least portion of the one or more candidate orders to the target fulfillment center comprises:
re-allocating the at least portion of the one or more candidate orders based on whether each order included in the one or more candidate orders can be processed in the target fulfillment center.

4. The method of claim 3,
wherein whether the each order included in the one or more candidate orders can be processed in the target fulfillment center is determined based on data relating to at least one of a quantity of stock received in the target fulfillment center, a number of workers in the target fulfillment center, or an address corresponding to the each order.

5. The method of claim 1, further comprising:
determining at least one order for a re-allocation attempt to the target fulfillment center among the one or more candidate orders prior to the re-allocating to the target fulfillment center,
wherein the at least one order for the re-allocation attempt comprises at least one order which is expected to be successfully re-allocated to the target fulfillment center based at least on a communication with another device, the another device in data communication with the electronic apparatus over the network and configured to manage a new order received for processing.

6. The method of claim 7, wherein the re-allocating to the target fulfillment center comprises:
attempting a re-allocation to the target fulfillment center for each of the at least one order determined for the re-allocation attempt.

7. The method of claim 6, further comprising:
transmitting data relating to a status associated with the re-allocation attempt to the target fulfillment center to the user terminal via the network, so as to enable the user terminal to display the data relating to the status associated with the re-allocation attempt.

8. The method of claim 7, wherein the data relating to the status includes at least one of:
a quantity of orders included in the one or more candidate orders;
a quantity of orders for which the re-allocation to the target fulfillment center is attempted; or
a quantity of orders successfully re-allocated to the target fulfillment center.

9. The method of claim 8,
wherein the data relating to the status further includes information relating to at least one of the target fulfillment center, delivery of an order, packing of an order, or a unit of an order quantity.

10. An electronic apparatus comprising:
a communication module; and
a processor, wherein the processor is configured to cause the electronic apparatus to:
receive, via the communication module and from a user terminal in data communication with the electronic apparatus over a network, data indicative of one or more attributes of a plurality of orders to re-allocate from a source fulfillment center to a target fulfillment center, the data based on one or more inputs received by the user terminal and including at least a requested number of orders for the re-allocation;
based on the received one or more attributes, identify at least one of the source fulfillment center or the target fulfillment center for the re-allocation;
based on the received one or more attributes, identify data relating to one or more candidate orders among a plurality of orders allocated to the source fulfillment center;
determine a number of the one or more candidate orders and a range of numbers of re-allocated orders which can be handled at the target fulfillment center;
based on the number of orders for the re-allocation being (i) less than or equal to the number of the one or more candidate orders and (ii) within the range of numbers of re-allocated orders, re-allocate at least a portion of the one or more candidate orders to the target fulfillment center, wherein the re-allocation of the at least portion of the candidate orders comprises:
causation of one or more products associated with the at least portion of the candidate orders to be transferred from the source fulfillment center to the target fulfillment center using one or more programmable devices;
determination, by the electronic apparatus, that at least one of picking, rebinning, or packing has been performed for at least one of the candidate orders at the source fulfillment center;
identification of one or more products associated with the at least one candidate order for which the at least one of the picking, the rebinning, or the packing has been performed; and
prevention of the identified one or more products from being transferred from the source fulfillment center to the target fulfillment center by the one or more programmable devices; and
transmit data relating to the re-allocated portion of the one or more candidate orders to the user terminal via the network, so as to enable the user terminal to display the data relating to the re-allocated portion of the one or more candidate orders.

11. The electronic apparatus of claim 10,
wherein the received one or more attributes are based on data relating to at least one of delivery of an order, packing of an order, or a current order processing status in the source fulfillment center.

12. The electronic apparatus of claim 10,
wherein the processor is configured to re-allocate the at least portion of the one or more candidate orders to the target fulfillment center based on whether each order included in the one or more candidate orders can be processed in the target fulfillment center.

13. The electronic apparatus of claim 12,
wherein the processor is configured to re-allocate the at least portion of the one or more candidate orders to the target fulfillment center based on data relating to at least one of a quantity of stock received in the target fulfillment center, a number of workers in the target fulfillment center, or an address corresponding to the each order.

14. The electronic apparatus of claim 10, wherein the processor is configured to:
determine at least one order for a re-allocation attempt to the target fulfillment center among the one or more candidate orders prior to the re-allocation to the target fulfillment center,
wherein the at least one order for the re-allocation attempt comprises at least one order which is expected to be successfully re-allocated to the target fulfillment center based at least on a communication with another device, the another device in data communication with the electronic apparatus over the network and configured to manage a new order received for processing.

15. The electronic apparatus of claim 14,
wherein the processor is configured to attempt re-allocation to the target fulfillment center for each of the at least one order determined for the re-allocation attempt.

16. The electronic apparatus of claim 15,
wherein the processor is configured to transmit data relating to a status associated with the re-allocation attempt to the target fulfillment center to an external device through the communication module.

17. The electronic apparatus of claim 16,
wherein the data relating to the status includes at least one of a quantity of orders included in the one or more candidate orders, a quantity of orders for which the re-allocation to the target fulfillment center is attempted, or a quantity of orders successfully re-allocated to the target fulfillment center.

18. A non-transitory computer readable recording medium comprising a computer program for performing the method of claim 1.
